(19) United States
(12) Patent Application Publication
(10) Pub. No.: US 2018/0370654 A1
(43) Pub. Date: Dec. 27, 2018

(54) MULTIPLE ENERGY SOURCE GUIDANCE SYSTEM AND METHOD FOR DRONES

(71) Applicant: Walmart Apollo, LLC, Bentonville, AR (US)

(72) Inventors: Robert L. Cantrell, Herndon, VA (US); Donald R. High, Noel, MO (US); Brian G. McHale, Chadderton Oldham (GB); David C. Winkle, Bella Vista, AR (US); Michael D. Atchley, Springdale, AR (US); John J. O'Brien, Farmington, AR (US); Nathan G. Jones, Bentonville, AR (US)

(21) Appl. No.: 15/994,593

(22) Filed: May 31, 2018

Related U.S. Application Data
(60) Provisional application No. 62/522,938, filed on Jun. 21, 2017.

(51) Int. Cl. B64F 1/20; G05D 1/04; B64C 39/02; G06Q 10/08; G01S 3/789

(52) U.S. Cl. CPC B64F 1/20; G05D 1/042; B64C 39/024; B64C 2201/208; G01S 3/789; B64C 2201/128; B64C 2201/187; G06Q 10/083

(57) ABSTRACT

When a first laser beam and a second laser beam are directed to the volume of space, an aerial drone is configured to lock onto the first laser beam using a first sensor, and to utilize the first laser beam to guide the drone to an accurate landing at a landing site. The aerial drone is further configured to lock onto the second laser beam using a second sensor, to determine a relationship between the first laser beam and the second laser beam, and to utilize the relationship to adjust the tilt of the aerial drone, the orientation of the aerial drone, the speed differential between the aerial drone and the landing site, and/or the alignment of a portion of the drone with a portion of the landing site when making the landing.

### CROSS-REFERENCE TO RELATED APPLICATION

This application claims the benefit of the following U.S. Provisional Application No. 62/522,938 filed Jun. 21, 2017, which is incorporated herein by reference in its entirety.

### TECHNICAL FIELD

These teachings relate generally to aerial drones and, more specifically, to guiding the takeoffs and/or landings of these drones using one or more directed energy sources.

### BACKGROUND

Aerial drones are in use today and perform a variety of functions. For example, aerial drones can be used to deliver packages from a shipping source (such as a distribution center) to a destination (such as a home). In other examples, aerial drones can be equipped with cameras, and can be used for surveillance purposes.

An aerial drone first takes off from a location, and later must land at the same or a different location. These landing (or waypoint) locations may be on the ground, on a moving vehicle, or on another aerial drone (while the other aerial drone has landed on the ground or in flight), to mention a few examples.

Drone take-offs and landings are activities that are often difficult to accomplish. Drone accidents often times occur during take-offs and landings due to wind, precipitation, or other hazards. In these conditions, drones can deviate off-course and crash into nearby buildings, people, or trees. In other examples, the tilt or relative orientation of the drone can be less than optimal, causing damage to the drone during take-offs and landings.

### BRIEF DESCRIPTION OF THE DRAWINGS

The above needs are at least partially met through provision of approaches that take actions relating to guiding aerial drones during take-offs and landings particularly when studied in conjunction with the drawings, wherein:

FIG. 1 comprises a diagram of a system as configured in accordance with various embodiments of these teachings;

FIG. 2 comprises a flowchart as configured in accordance with various embodiments of these teachings;

FIGS. 3A-E comprises a diagram of a system as configured in accordance with various embodiments of these teachings;

FIG. 4 comprises a diagram of a system as configured in accordance with various embodiments of these teachings;

FIG. 5 comprises a diagram of a system as configured in accordance with various embodiments of these teachings;

FIG. 6 comprises a diagram of a system as configured in accordance with various embodiments of these teachings; and

FIG. 7 comprises a diagram of a system as configured in accordance with various embodiments of these teachings.

### DETAILED DESCRIPTION

Generally speaking, many of these embodiments provide for a system and method that utilize two or more energy sources (e.g., two directed laser beams) to navigate an aerial drone during landings and/or take-offs. In one example and during a landing of the drone, the drone is first navigated to the general area of the landing site using conventional navigational approaches (e.g., using GPS or DGPS systems or approaches). Then, two laser beams are directed from the landing area to the volume of space above the landing area in which the aerial drone is operating or hovering. Next, the drone uses one of the lasers to guide the drone to a safe landing. The drone also determines and utilizes the spatial relationship between the lasers to adjust the orientation (e.g., relative position and/or pitch) of the drone as needed during the landing.

In many of these embodiments, a retail product delivery system is configured to guide an aerial drone to deliver one or more commercial products to a customer using two or more lasers (or other directed energy sources). The system includes a first laser device, a second laser device, an aerial drone, and a control circuit.

The first laser device is configured to transmit a first laser beam, and the second laser device is configured to transmit a second laser beam. The aerial drone includes a first sensor and a second sensor, and is configured to carry and deliver the one or more commercial products to the customer.

The control circuit is configured to transmit first instructions to the aerial drone. The first instructions are effective to guide the aerial drone to become positioned within a selected volume of space that is within a predetermined distance of a landing site. The control circuit is configured to, when the aerial drone becomes positioned within the selected volume of space, transmit second instructions to the first laser device to direct the first laser beam within the volume of space. The control circuit is configured to transmit third instructions to the second laser device to direct the second laser beam within the volume of space.

When the first laser beam and the second laser beam are directed to the volume of space, the aerial drone is configured to lock onto the first laser beam using the first sensor, and to utilize the first laser beam to guide the drone to an accurate landing at the landing site. The aerial drone is configured to lock onto the second laser beam using the second sensor. The aerial drone is configured to determine a relationship between the first laser beam and the second laser beam, and utilize the relationship to adjust one or more of: a tilt of the aerial drone when making a landing at the landing site, an orientation of the aerial drone when making the landing, a speed differential between the aerial drone and the landing site when making the landing, or an alignment of a portion of the drone with a portion of the landing site when making the landing.

In aspects, the relationship comprises a distance and angular relation between the first sensor and the second sensor. Other examples are possible.

In examples, the landing site is one of: the ground, a runway on a vehicle, or a second aerial drone. Other examples are possible.

In still other examples, the alignment of a portion of the drone with a portion of the landing site comprises an alignment between a first docking port on the aerial drone with a second docking port on a second aerial drone. The docking port may be any structure that facilitates a physical connection between two drones.

In yet other examples, communications are exchanged between the aerial drone and the control circuit. The communications are effective to coordinate locating the first laser beam and the second laser beam when the control circuit at the landing site is aware of the aerial drone, but the aerial drone has not yet found the landing site.

In yet other aspects, communications are also exchanged between the aerial drone and the control circuit. In this case, the communications are effective to coordinate locating the first laser beam and the second laser beam when the aerial drone is aware of the landing site, but the control circuit has not yet found the aerial drone.

In aspects, the first laser beam has a first frequency and the second laser beam has a second frequency. The first frequency is different from the second frequency. In other aspects, the first laser beam comprises first encoded information and the second laser beam comprises second encoded information. In crowded environments where many drones are operating, the encoding may be used to ensure that the correct laser beam is captured and used by the correct drone.

In some other examples, the sensors comprise a device such as a matrix sensor, or sensors on a ring. Other examples are possible.

In other examples, the control circuit is disposed at a location such as at a central processing location, at the aerial drone, or both at the aerial drone and at a central processing location. Other examples and combinations are possible.

In others of these embodiments, a first laser device is configured to transmit a first laser beam, and a second laser device is configured to transmit a second laser beam. An aerial drone is configured with a first sensor and a second sensor.

First instructions are transmitted from a control circuit to the aerial drone. The first instructions are effective to guide the aerial drone to become positioned within a selected volume of space that is within a predetermined distance of a landing site.

When the drone becomes positioned within the selected volume of space, second instructions are transmitted from the control circuit to the first laser device to direct the first laser beam within the volume of space. Third instructions are transmitted to the second laser device to direct the second laser beam within the volume of space.

When the first laser beam and the second laser beam are directed to the volume of space, the aerial drone is configured to lock onto the first laser beam using the first sensor, and to utilize the first laser beam to guide the drone to an accurate landing at the landing site. The aerial drone is further configured to lock onto the second laser beam using the second sensor, to determine a relationship between the first laser beam and the second laser beam, and to utilize the relationship to adjust the tilt of the aerial drone, the orientation of the aerial drone, the speed differential between the aerial drone and the landing site, and/or the alignment of a portion of the drone with a portion of the landing site when making the landing.

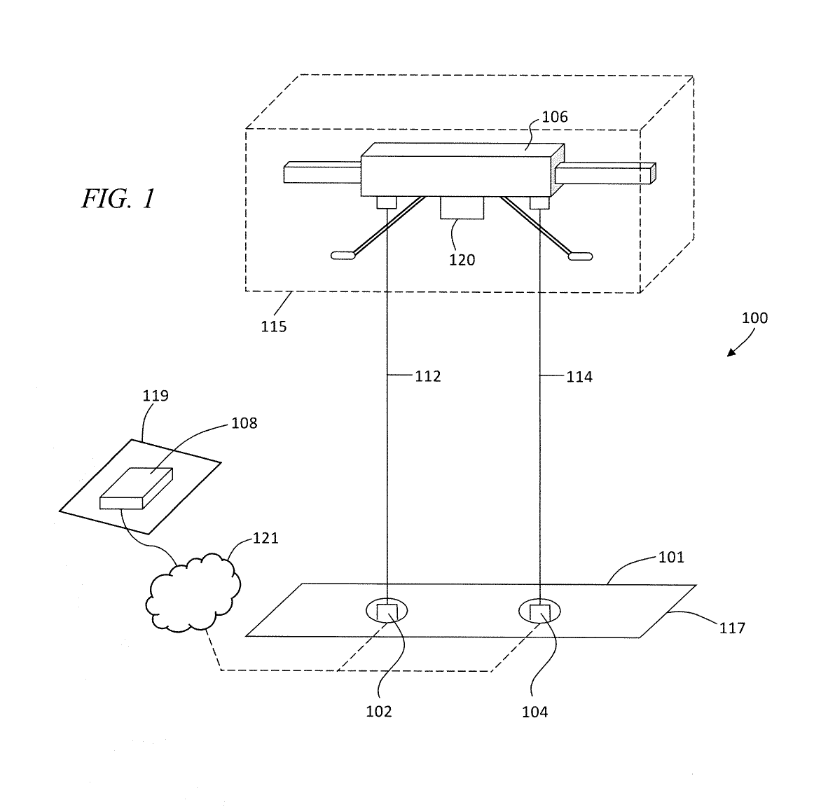

Referring now to FIG. 1, one example of a system 100 for guiding aerial drones during take-offs and/or landings is described. The system includes a first laser device 102, a second laser device 104, an aerial drone 106, and a control circuit 108.

The first laser device 102 is configured to transmit a first laser beam 112, and the second laser device 104 is configured to transmit a second laser beam 114. Although described herein as being laser beams, it will be appreciated that any type of directed energy source such as RF energy, or acoustic energy can be used. Further, pressure readings, LED lighting, RFID beacons, WiFi signals, sonar signals, and radar signals can be used. If lasers are used, the laser beams may be visible or invisible to the human eye. In addition, the laser devices 102 and 104 are shown as being on the ground. In other examples, the devices 102 and 104 may be located on a moving vehicle (e.g., an automated ground vehicle or other drone). In yet other examples, the laser devices 102 and 104 are on the drone 106, and the sensors are at the landing site 117. In still other examples, the laser devices 102 and 104 may be located at a fixed based station (e.g., on a tower).

In aspects, the first laser beam 112 has a first frequency and the second laser beam 114 has a second frequency. The first frequency is different from the second frequency. In other aspects, the first laser beam 112 comprises first encoded information and the second laser beam 114 comprises second encoded information. The laser beams 112, 114 may be shaped (and this may facilitate determining the orientation of the drone 106) and a single laser beam may be used if the laser is shaped. In other examples, the laser beams can be emitted from a laser device that is configured to rotate (e.g., as a rotating ball).

In specific examples, the color of the laser beams 112 and 114 can be adjusted, and/or the laser beams 112 and 114 may be pulsed. If the laser beams 112 and 114 are pulsed, the pulsing may occur in unique ways (e.g., timings or patterns) to allow the drone to locate and lock onto a particular laser beam. The pulse may be encoded with a unique identity or identifier that is used to minimize errors thereby allowing multiple drones to operate in the same vicinity (or in close proximity) where each drone operates with, engages, or locks onto specifically selected and identified laser beams. The encoding also provides a level of integrity to minimize jamming attempts by unauthorized parties, thereby increasing security of the system. In still other aspects, lasers may be transmitted from the drone and the Doppler Effect can be used to determine whether the drone is either moving toward or away from the landing site to allow for flight adjustments to be made.

The aerial drone 106 includes a first sensor 142 and a second sensor 144, and is configured to carry and deliver the one or more commercial products 120 to the customer. The sensors 142 and 144 are any type of device that can sense a laser beam. For example, the sensors may be flat sensors divided into four quadrants that sense the presence of a laser (or other directed energy) beam. In still other examples, the sensors 142 and 144 are structured as rings or elongated strips. Other types of structures and configurations are possible for the sensors 142 and 144.

The control circuit 108 is disposed in the vicinity of the landing area 101 in this example. In other examples, the control circuit 108 may be disposed at the drone 106, or split between the drone 106 and the ground. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 108 may be configured (for example, by using corresponding programming stored in a memory as will be well understood by those skilled in the art) to carry out one or more of the steps, actions, and/or functions described herein.

The control circuit 108 is configured to transmit first instructions to the aerial drone 106. The first instructions (e.g., including GPS coordinates) are effective to guide the aerial drone 106 to become positioned within a selected volume of space 115 that is within a predetermined distance of a landing site 117. The control circuit 108 is further configured to, when the aerial drone 106 becomes positioned within the selected volume of space 115, transmit second instructions to the first laser device 102 in order to direct the first laser beam 112 within the volume of space 115. The control circuit 108 is still further configured to transmit third instructions to the second laser device 104 in order to direct the second laser beam 114 within the volume of space 115.

When the first laser beam 112 and the second laser beam 114 are directed to the volume of space 115, the aerial drone 106 is configured to lock onto the first laser beam 112 using the first sensor 142, and to utilize the first laser beam to guide the drone to an accurate landing at the landing site 117. The aerial drone 106 is configured to lock onto the second laser beam using the second sensor 144. The aerial drone is configured to determine a relationship between the first laser beam 112 and the second laser beam 114, and utilize the relationship to adjust one or more of: a tilt of the aerial drone 106 when making a landing at the landing site 117, an orientation of the aerial drone 106 when making the landing, a speed differential between the aerial drone 106 and the landing site 117 when making the landing, or an alignment of a portion of the drone 106 with a portion of the landing site 117 when making the landing.

The relationship between the first laser beam 112 and the second laser beam 114 can relate to a number of features. In some aspects, the relationship comprises a distance and angular relation between the first sensor 142 and the second sensor 144. Other examples are possible.

The landing site 117 may be the ground, a runway on a vehicle, or a second aerial drone. Other examples are possible. In one example, the control circuit 108 is disposed at a location such as at a central processing location 119 (and may communicate with the laser devices 102 and 104 via a communication network 121). In other examples, the control circuit 108 is located at the aerial drone, or both at the aerial drone and at a central processing location. Other examples and combinations are possible.

In examples, the alignment of a portion of the drone 106 with a portion of the landing site 117 comprises an alignment between a first docking port on the aerial drone 106 with a second docking port on a second aerial drone. The docking ports may be structures by which the two aerial drones connect or attach to each other.

In other examples, communications are exchanged between the aerial drone 106 and the control circuit 108. The communications are effective to coordinate locating the first laser beam 112 and the second laser beam 114 when the control circuit 108 at the landing site 117 (or at the central control center 119) is aware of the aerial drone 106, but the aerial drone 106 has not yet found the landing site 117. In yet other examples, communications are also exchanged between the aerial drone 106 and the control circuit 108. In this case, the communications are effective to coordinate locating the first laser beam 112 and the second laser beam 114 when the aerial drone 106 is aware of the landing site 117, but the control circuit 108 has not yet found the aerial drone 106.

The examples described herein apply to drone landings, but it will be appreciated that these approaches can also be applied to take-offs. More generally, these approaches can be used for precise guidance of drones in any aerial maneuver or movement.

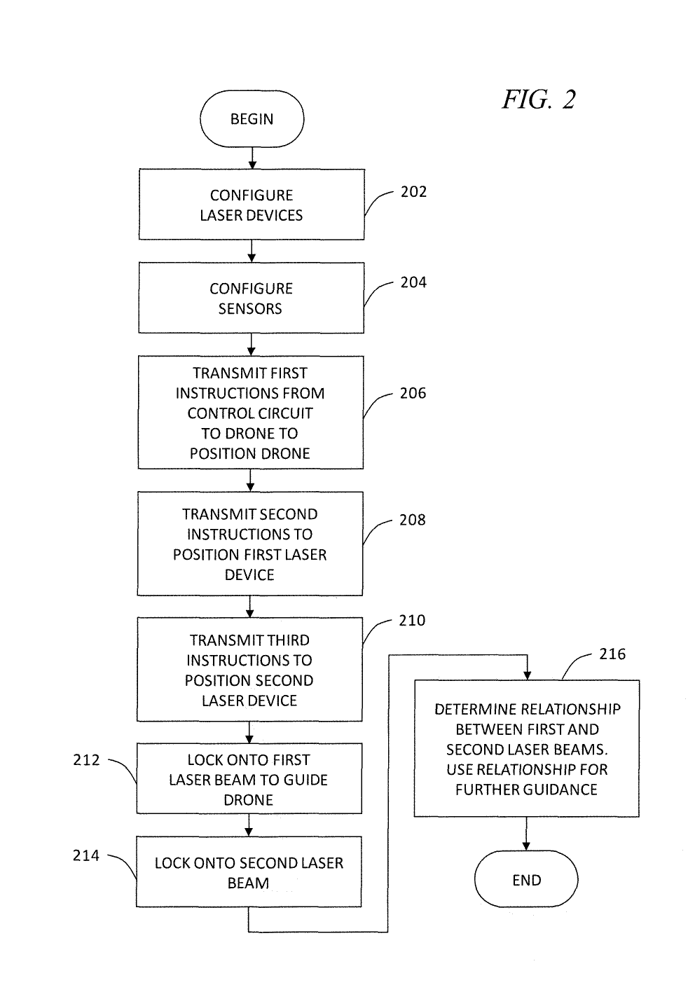

Referring now to FIG. 2, one example of an approach for landing an aerial drone is described. At step 202, a first laser device is configured to transmit a first laser beam, and a second laser device is configured to transmit a second laser beam. The first and second laser beams may be of the same frequency, but in other examples are of different frequencies (e.g., to enhance measurement accuracy). In other examples, various types of encoded information can be included in the laser beams. In specific examples, the color of the laser beams can be adjusted, and the laser beams may be pulsed. If the lasers are pulsed, the pulsing may be in unique ways (e.g., timings or patterns) to allow the drone to locate a laser. The pulse may be encoded with a unique identity or identifier that is used to minimize errors thereby allowing multiple drones to operate in the same vicinity where each drone operates with specifically selected and identified laser beams. The encoding also provides a level of integrity to minimize jamming attempts by unauthorized parties, thereby increasing security of the system.

At step 204, an aerial drone is configured with a first sensor and a second sensor. The sensors may be configured or structured in a variety of ways such as a matrix or as a ring. Other examples are possible.

At step 206, first instructions are transmitted from a control circuit to the aerial drone. The first instructions are effective to guide the aerial drone to become positioned within a selected volume of space that is within a predetermined distance of a landing site. In examples, geographic coordinates and an altitude are transmitted to the aerial drone and the drone flies to these coordinates and altitude where the drone hovers.

At step 208 and when the drone becomes positioned within the selected volume of space, second instructions are transmitted from the control circuit to the first laser device to direct the first laser beam within the volume of space. The first laser device is constructed and structured so as to be able to aim its laser beam so as to pass through volumes of space above the landing site.

At step 210, third instructions are transmitted to the second laser device to direct the second laser beam within the volume of space. As with the first laser device, the second laser device is constructed so as to be able to aim its laser beam so as to pass through volumes of space above the landing site.

At step 212, when the first laser beam and the second laser beam are directed to the volume of space, the aerial drone locks onto the first laser beam using the first sensor, and utilizes the first laser beam to guide the drone to an accurate landing at the landing site. In examples and when a four-quadrant matrix sensor is used, the quadrant where the laser beam strikes the sensor determines an adjustment of the landing of the drone. For instance, if the beam strikes a certain quadrant, the aerial drone is configured to move to the left. If the laser strikes or impacts another quadrant, the drone is configured to move to the right as it lands. In this way, adjustments to the position of the drone when landing can be made.

At step 214, the aerial drone locks onto the second laser beam using the second sensor. By “locking,” it is meant that the drone finds, receives, obtains, and/or senses a laser beam. In some aspects, a drone may be assigned to one or more laser beams. In examples, the drone may store identifiers that are associated with particular laser beams. Laser beams are encoded with separate identifiers such that the drone will compare the encoded identifier to its stored predetermined identifier(s). If there is a match, then the drone has found a correct laser beam and can then use the laser beam as guidance in take-offs and landings as described herein. If a match is not found, then the drone ignores the laser beam.

At step 216, the aerial drone determines a relationship between the first laser beam and the second laser beam. In examples, the relationship is a distance and angular relation between the first sensor and the second sensor. The distance between the sensors may be fixed. Since the positions of the first and second sensors relative to each other are known (e.g., these may be programmed or stored at the drone), since the positions of the laser devices emitting the laser beams are known (e.g., these may be programmed or stored at the drone), and since the altitude of the drone is known or can be ascertained (e.g., using an altimeter or from information sent from the ground), then (as known to those skilled in the art) mathematical and geometric relationships can be used to calculate the angular relationship between the first sensor (e.g., the drone is disposed parallel to the ground so the angle is 180 degrees, or the drone is tilted at a 45 degree angle with respect to the ground).

The determined relationship is utilized to adjust a variety of parameters. For instance, the tilt of the aerial drone when making a landing at the landing site, the orientation of the aerial drone when making the landing, the speed differential between the aerial drone and the landing site when making the landing (e.g., when the landing site is a moving vehicle), and/or the alignment of a portion of the drone with a portion of the landing site when making the landing (e.g., a port on a drone is aligned with a port on another drone when the landing site is the other drone) can all be adjusted. By “alignment” it is meant that a certain portion of the drone is facing a certain direction. For example, it may be desirable that a “front” of a drone faces north.

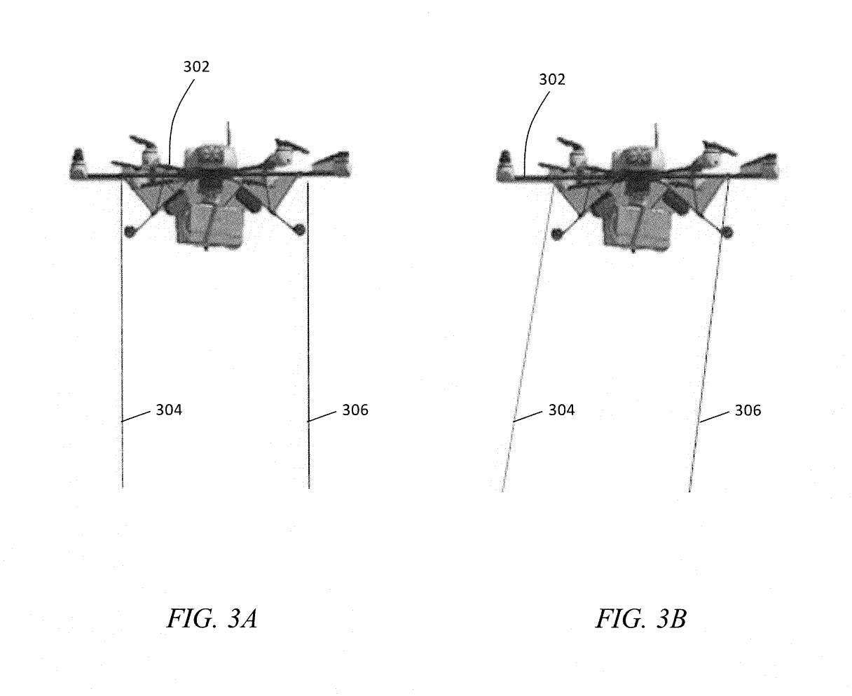

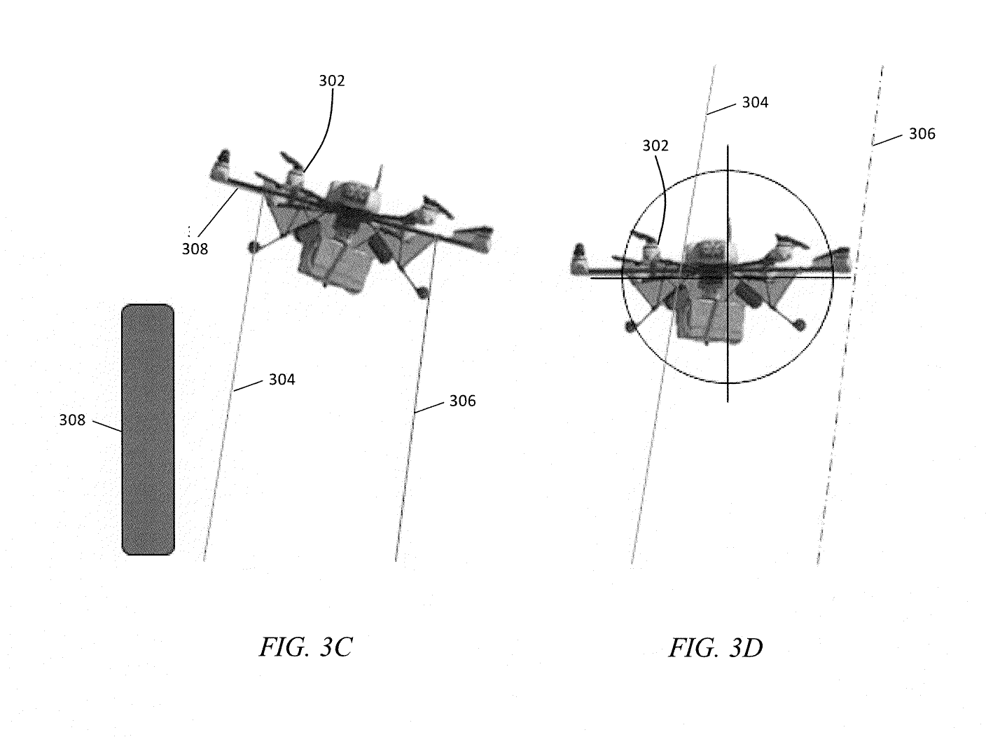

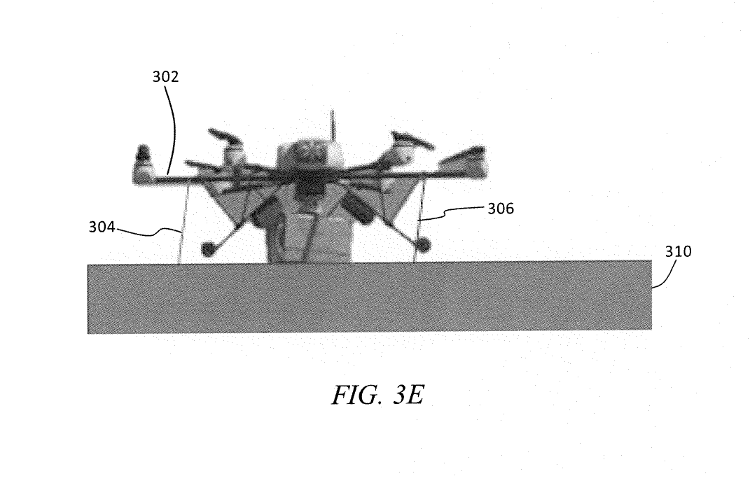

Referring now to FIGS. 3A-3E, various drone operations are described. As shown in FIG. 3A, a drone 302 is directed by a first laser beam 304 and a second laser beam 306. In some examples, more than two laser beams can be used. In yet other examples, a single laser beam is used.

The laser beams 304 and 306 assist the landing of the drone 302 as described elsewhere herein. The drone 302 is guided to an exact spot on a landing area (e.g., a tray, drawer or landing pad). In examples, the laser beams 304 and 306 are eye safe and are invisible to the human eye.

As shown in FIG. 3B, the laser beams 304 and 306 are shown as being tilted with respect to the ground and/or the drone 302. The laser devices producing the laser beams 304 and 306 tilt to find the drone 302. In examples, once the first laser beam 304 hits an optical tracker or sensor on the drone 302, the drone 302 and/or the second laser beam 306 can change orientation to connect with or sense the second laser beam 306. The orientation (e.g., certain portions of the drone 302 face certain directions), tilt, roll, and speed of the drone can be set. The drone 302 can land on the ground, or on non-stationary objects (whether the object is moving or at rest).

As shown in FIG. 3C, a laser sensing strip 308 positioned on a bottom surface of the drone 308 is shown. The laser sensing strip 308 is of sufficient length to account for incidental tipping of the drone (e.g., during high winds). The drone 302 communicates altitude and attitude to the ground, in some aspects.

As shown in FIG. 3D, optical or pulse aimer aspects of the present approaches are described. A broader optical aimer may be used to establish where the drone is to assist the laser beams 304 and 306 in finding their targets. For example, the drone 302 may utilize GPS coordinates (e.g., supplied by a GPS or DGPS system) to navigate to a general area where one or more of the beams 304 and 306 locate the drone.

The drone 302 may also look or search for the laser beam with a predetermined pulse pattern or for a beam that includes other identification information. Once such a beam is located, then the drone 302 may lock onto the beam and use the beam for guidance in take-offs and/or landings. If the sensed beam does not include the required identification information, then the beam can be ignored.

As shown in FIG. 3E, the drone comes to a safe landing on a landing area 310. In this example, the landing area may be on the ground. Other examples of landing sites are possible.

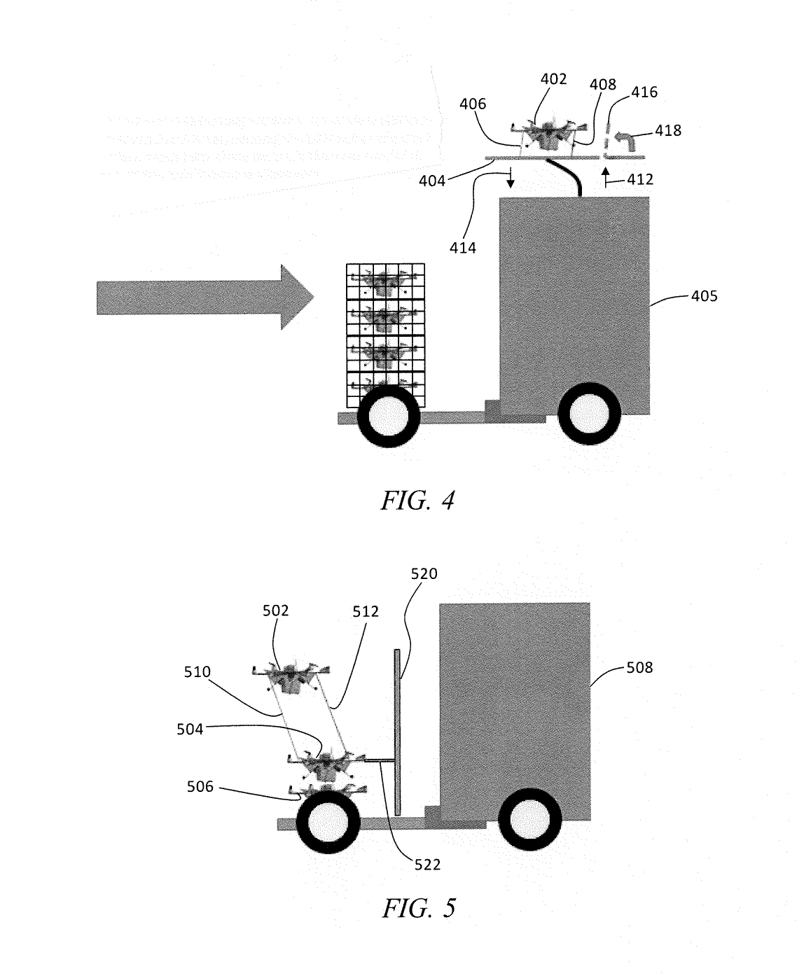

Referring now to FIG. 4, one example of a drone landing on a platform of an automated ground vehicle is described. An aerial drone 402 hovers and lands on a platform 404 of an automated ground vehicle 405 being guided in the landing by a first laser 406 and a second laser 408. The landing occurs according to the approaches described herein.

The drone 402 hovers close enough to the automated ground vehicle 405 so that the platform 404 is raised upward in the direction indicated by the arrow labeled 412. Once secure, the platform 404 may be lowered in the directed indicated by the arrow labeled 414. A flap 416 may be raised after the drone 402 is secured to protect the drone 402, for example, from airflow as the automated ground vehicle 405 moves. The flap 416 is moved in the direction indicated by the arrow labeled 418.

Referring now to FIG. 5, one example of drone stacking is described. A first aerial drone 502 hovers and lands on a second drone 504, which itself has landed on a third drone 506. The drones 502, 504, and 506 stack on a surface of an automated ground vehicle 508 and are guided to landings by a first laser 510 and a second laser 512. The landing occurs according to the approaches described herein. A retractable bar 520 is connected to a clamp 522. The clamp 522 is coupled to one of the drones to secure the stack of drones from swaying and/or toppling.

Each of the drones 502, 504, and 506 may have ports. The ports are structures or mechanisms that allow one drone to attach to another drone. For instance, latches, hooks, or other mechanisms can be used. Other examples are possible.

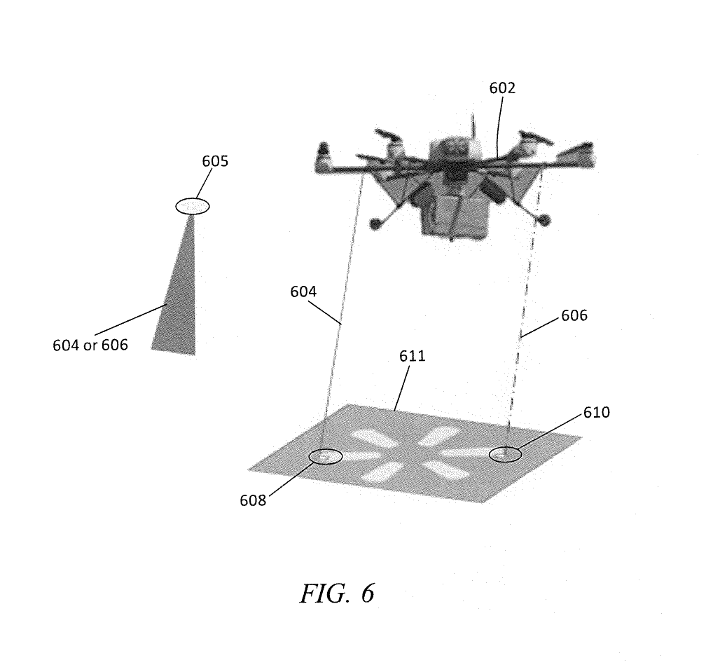

Referring now to FIG. 6, on example of a drone carrying the lasers is described. In this example a drone 602 carries a first laser device emitting a first laser beam 604 and a second laser device emitting a second laser beam 606. The laser beams 604 and 606 are received at sensors 608 and 610 at a landing area 611. A diffuser 605 (diffusing or spreading the laser beams) may help the sensors 608, 610 locate the beams before the beams are narrowed.

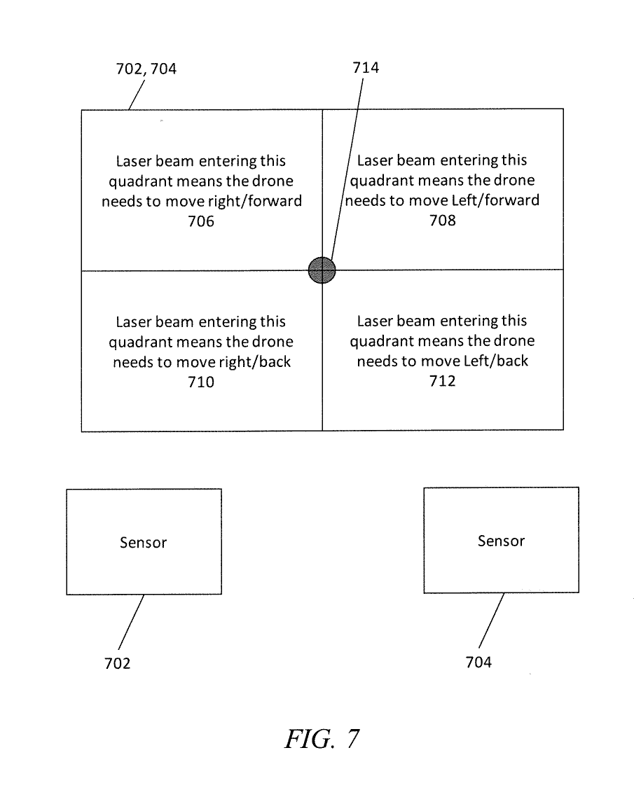

Referring now to FIG. 7, one example of a sensor 702, 704 that is deployed on an aerial drone is described. The sensor 702, 704 is divided into a first quadrant 706, a second quadrant 708, a third quadrant 710, a fourth quadrant 712, and a central portion 714.

If both beams miss the sensors 702, 704 then the drone re-locates to find one of the beams. If a beam finds the sensor 702, but not the sensor 704 then the drone spins to find the second laser beam. If a beam finds the sensor 704, but not the sensor 702 then the drone spins to find the first laser beam. If both beams are located and the orientation of drone is correct, the drone does not have to move. If the incorrect laser beam is hitting the incorrect sensor, then the orientation of the drone is off by 180 degrees and the drone may spin 180 degrees. Each sensor may be programmed to receive a particular laser beam, so that when this occurs the alignment of the drone will be known to be correct.

For one or both of the sensors 702, 704, the quadrant where a laser beam enters and is sensed causes the drone to move in certain ways or directions. To take one example, if the laser beam enters the first quadrant 706, the drone moves right and forward. If the laser beam enters the second quadrant 708, then the drone moves left and forward. If the laser beam enters the third quadrant 710, then the drone moves right and backward. If the laser beam enters the fourth quadrant 712, then the drone moves left and backward. If the laser beam enters the central portion 714, the drone does not move since this is the desired position.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A retail product delivery system that is configured to guide an aerial drone configured to deliver one or more commercial products to a customer through the use of two or more lasers, the system comprising:
a first laser device that is configured to transmit a first laser beam, and a second laser device configured to transmit a second laser beam;
an aerial drone including a first sensor and a second sensor and configured to carry and deliver the one or more commercial products to the customer;
a control circuit, the control circuit configured to:
transmit first instructions to the aerial drone, the first instructions being effective to guide the aerial drone to become positioned within a selected volume of space that is within a predetermined distance of a landing site; and
when the aerial drone becomes positioned within the selected volume of space, transmit second instructions to the first laser device to direct the first laser beam within the volume of space and to transmit third instructions to the second laser device to direct the second laser beam within the volume of space;
when the first laser beam and the second laser beam are directed to the volume of space, the aerial drone is configured to:
lock onto the first laser beam using the first sensor, and to utilize the first laser beam to guide the drone to an accurate landing at the landing site;
lock onto the second laser beam using the second sensor; and
determine a relationship between the first laser beam and the second laser beam, and utilize the relationship to adjust one or more of: a tilt of the aerial drone when making a landing at the landing site, an orientation of the aerial drone when making the landing, a speed differential between the aerial drone and the landing site when making the landing, and an alignment of a portion of the drone with a portion of the landing site when making the landing.

2. The system of claim 1, wherein the relationship comprises a distance and angular relation between the first sensor and the second sensor.

3. The system of claim 1, wherein the landing site is one of: the ground, a runway on a vehicle, or a second aerial drone.

4. The system of claim 1, wherein the alignment of a portion of the drone with a portion of the landing site comprises an alignment between a first docking port on the aerial drone with a second docking port on a second aerial drone.

5. The system of claim 1, wherein communications are exchanged between the aerial drone and the control circuit, the communications being effective to coordinate locating the first laser beam and the second laser beam when the control circuit at the landing site is aware of the aerial drone, but the aerial drone has not yet found the landing site.

6. The system of claim 1, wherein communications are exchanged between the aerial drone and the control circuit, the communications being effective to coordinate locating the first laser beam and the second laser beam when the aerial drone is aware of the landing site, but the control circuit has not yet found the aerial drone.

7. The system of claim 1, wherein the first laser beam has a first frequency and the second laser beam has a second frequency, and the first frequency is different from the second frequency.

8. The system of claim 1 wherein the first laser beam comprises first encoded information and the second laser beam comprises second encoded information.

9. The system of claim 1 wherein the sensors comprise a device selected from the group consisting of a matrix sensor, and sensors on a ring.

10. The system of claim 1, wherein the control circuit is disposed at a location selected from the group consisting of: a central processing location, the aerial drone, and both at the aerial drone and at a central processing location.

11. A method of guiding an aerial drone using two or more lasers, the method comprising:
configuring a first laser device to transmit a first laser beam, and a second laser device to transmit a second laser beam;
configuring an aerial drone with a first sensor and a second sensor;
transmitting first instructions from a control circuit to the aerial drone, the first instructions being effective to guide the aerial drone to become positioned within a selected volume of space that is within a predetermined distance of a landing site;
when the drone becomes positioned within the selected volume of space, transmitting second instructions from the control circuit to the first laser device to direct the first laser beam within the volume of space and to transmit third instructions to the second laser device to direct the second laser beam within the volume of space;
when the first laser beam and the second laser beam are directed to the volume of space, the aerial drone is configured to lock onto the first laser beam using the first sensor, and to utilize the first laser beam to guide the drone to an accurate landing at the landing site, the aerial drone being further configured to lock onto the second laser beam using the second sensor, the aerial drone being further configured to determine a relationship between the first laser beam and the second laser beam, and to utilize the relationship to adjust one or more of: a tilt of the aerial drone when making a landing at the landing site, an orientation of the aerial drone when making the landing, a speed differential between the aerial drone and the landing site when making the landing, and an alignment of a portion of the drone with a portion of the landing site when making the landing.

12. The method of claim 11, wherein the relationship comprises a distance and angular relation between the first sensor and the second sensor.

13. The method of claim 11, wherein the landing site is one of: the ground, a runway on a vehicle, or a second aerial drone.

14. The method of claim 11, wherein the alignment of a portion of the drone with a portion of the landing site comprises an alignment between a first docking port on the aerial drone with a second docking port on a second aerial drone.

15. The method of claim 11, further comprising exchanging communications between the aerial drone and the control circuit, the communications being effective to coordinate locating the first laser beam and the second laser beam when the control circuit at the landing site is aware of the aerial drone, but the aerial drone has not yet found the landing site.

16. The method of claim 11, further comprising exchanging communications between the aerial drone and the control circuit, the communications being effective to coordinate locating the first laser beam and the second laser beam when the aerial drone is aware of the landing site, but the control circuit has not yet found the aerial drone.

17. The method of claim 11, wherein the first laser beam has a first frequency and the second laser beam has a second frequency, and the first frequency is different from the second frequency.

18. The method of claim 11 wherein the first laser beam comprises first encoded information and the second laser beam comprises second encoded information.

19. The method of claim 11 wherein the sensors comprise a device selected from the group consisting of a matrix sensor, and sensors on a ring.

20. The method of claim 11, wherein the control circuit is disposed at a location selected from the group consisting of: a central processing location, the aerial drone, and both at the aerial drone and at a central processing location.
